(19) United States
(12) Patent Application Publication
(10) Pub. No.: US 2023/0342648 A1
(43) Pub. Date: Oct. 26, 2023

(54) QUANTUM COMPUTING DEVICE BASED ON INDIVIDUAL RYDBERG ATOMS

(71) Applicants: CENTRE NATIONAL DE LA RECHERCHE SCIENTIFIQUE, PARIS (FR); INSTITUT D'OPTIQUE THÉORIQUE ET APPLIQUÉE, PALAISEAU (FR)

(72) Inventors: Thierry LAHAYE, PALAISEAU (FR); Antoine BROWAEYS, ORSAY (FR); Florence NOGRETTE, PARIS (FR); Daniel BARREDO, ANTONY (FR); Kai-Niklas SCHYMIK, PARIS (FR)

(21) Appl. No.: 17/799,287

(22) PCT Filed: Feb. 12, 2021
(86) PCT No.: PCT/EP2021/053488

§ 371 Date: Aug. 12, 2022

(30) Foreign Application Priority Data
Feb. 19, 2020 (FR) 2001646

(51) Int. Cl. G06N 10/40; G21K 1/00

(52) U.S. Cl. CPC G06N 10/40; G21K 1/006

(57) ABSTRACT

A quantum-computing device includes an atom-trapping unit configured to generate a three-dimensional array of optical tweezers in an ultra-high-vacuum chamber; an atom source, for generating a beam of atoms that is directed toward the space containing the three-dimensional array of optical tweezers; a magneto-optical system for cooling the atoms, the system being configured to generate, in the space containing the array, a gray molasses; and a system for applying quantum logic gates to atoms trapped in the optical tweezers of the array; and a cryostat for establishing a cryogenic temperature in the ultra-high-vacuum chamber; the atom-trapping unit comprising two lens-holding barrels placed facing, each barrel holding one of the aspherical lenses with a sufficient clearance to compensate for a differential in thermal contraction between the barrel and the lens during a passage from an ambient temperature to a cryogenic temperature.

The invention relates to a quantum processor and more particularly to a quantum-computing device based on individual Rydberg atoms.

In quantum computing, the smallest element of information is the quantum bit or qubit, which is embodied by an object that obeys the rules of quantum physics and that possesses two basis states commonly denoted |10> and |1>. Contrary to conventional computing in which the smallest element of information is a conventional bit that is equal either to 0, or to 1, a qubit is able to take an infinite number of possible values through coherent superposition of the basis states. Thus, applying a logic operation to a qubit amounts to applying it simultaneously to the state |10> and to the state |1>, whereas, in conventional computing, it amounts to applying it successively to the bit 0 then to the bit 1 to process the two possible values. The advantage of this parallelism in the processing of information increases as the amount of information increases. By way of example, manipulating 10 qubits amounts to manipulating in one go 2¹⁰=1024 possible values. Furthermore, quantum computing is based on the entanglement effect whereby N entangled qubits form a linked system and each have a quantum state that is dependent on the others irrespectively of the distance separating them. Thus, modifying the state of one qubit instantaneously modifies the states of the other qubits. Entanglement allows, in particular, qubits to be projected into given states by modifying other qubits. The potential of quantum computing in terms of computing power is nevertheless limited by the effect of decoherence, which results in a loss of quantum superposition, and therefore of computing power. Decoherence is mainly caused by the environment and the mechanical, electrical, etc. disturbances that it generates. Decoherence may be corrected for via error correction codes based on redundancy. By way of example, about 10 000 physical qubits are required to form 1 logical qubit.

Whereas production of a quantum computer able to manipulate a significant number of logical qubits remains a far-off objective, processors incorporating a low number of physical qubits, generally lower than 100, have been proposed and made available commercially. Such processors are generally designated NISQ processes (NISQ standing for noisy intermediate-scale quantum) and are generally capable of carrying out certain tasks that are beyond the ability of conventional computers, see for example [Preskill 2018]. NISQ processors are particularly suitable for combinatorial optimization problems. The performance of NISQ processors in terms of computing power is directly related to the number of qubits employed. NISQ processors may be classed depending on the type of qubits employed, which may be: superconducting qubits, trapped ions, photons, electron spins, individual Rydberg atoms, etc.

The technology of quantum processors based on individual Rydberg atoms is a promising candidate for production of NISQ processors liable to have practical applications. This technology employs an array of optical tweezers each of which is capable of trapping at most one electrically neutral and previously cooled atom for a time interval that is highly dependent on environmental disturbances. A qubit is encoded in two Zeeman sub-levels of each trapped atom immersed in a magnetostatic field. Raman pulses are used to apply gates to a qubit, i.e. to manipulate the state of a single qubit. To apply two-qubit gates, which require interactions between two atoms, the latter are excited to Rydberg levels. Specifically, Rydberg atoms have electric dipoles of high dipole moment, this making strong Van der Waals interactions possible even over distances of several tens of microns. A general introduction to quantum computing with Rydberg atoms is provided by [Saffman 2010].

State-of-the-art NISQ processors based on individual Rydberg atoms employ a limited number (lower than 50) of Rydberg atoms, and therefore qubits. Increasing the number of qubits to the scale of 1000 to meet the ever-increasing need for computing power using the architectures employed poses a certain number of problems. Specifically, conventional architectures employ a two-dimensional (2D) array of optical tweezers that are loaded with individual atoms through a magneto-optical trapping mechanism, and that are formed using an aspherical lens capable of focusing a laser beam into a spot of size smaller than 1 micron. The performance in terms of fill ratio of such a trapping mechanism is of the order of 50%, this meaning that 2000 optical tweezers, distributed, for example, in an array of 45×45 size, are required to obtain 1000 qubits. The assembling process consists in succession in: (i) triggering loading with atoms of the elements of the array, (ii) locating optical tweezers that have actually trapped an atom, and (iii) moving the trapped atoms to form an ordered array of 1000 atoms. Given that a spacing of 5 microns is required between two adjacent traps, a square array that is 45×45 optical tweezers in size corresponds to a square area of more than 200 microns per side. A typical aspherical lens characterized, for example, by a numerical aperture (NA) equal to 0.5 and a focal length of 10 millimeters is incapable of covering an area of 200 microns per side without geometric aberrations, i.e. aberrations such as coma in particular, leading to the formation of spots of several microns. Furthermore, the optical power required to generate an optical tweezer is of the order of 5 mW, this corresponding to a total laser-beam power of the order of 10 W. This in particular leads to thermal problems affecting the performance of the quantum processor.

Moreover, the time taken to assemble an array of atoms increases linearly with the number of atoms to be assembled, the average time taken per atom being one millisecond. Conventional NISQ-processor architectures based on individual Rydberg atoms operate in an ultra-high vacuum under a residual gas pressure of the order of 10⁻¹² mbar. In such a vacuum, the lifetime of an array of atoms is limited as a result of collisions with the atoms of the residual gases and varies according to a decreasing exponential law with a time constant of 10/N seconds. Thus, once N exceeds about one hundred, the assembly time exceeds the lifetime of the configuration, making assembly impossible.

The documents [Leseleuc de Kerouara 2018] and [Barredo 2018] disclose the ability to form three-dimensional arrays of trapped atoms, and of using them to perform quantum simulation by means of Rydberg states. The number of atoms trapped may reach 100.

[Leseleuc de Kerouara 2018] moreover envisions the possibility of forming arrays of trapped atoms of larger sizes by placing them in a cryogenic environment. However, no technical detail is given on the actual implementation of a cryogenic Rydberg-atom quantum processor.

There is therefore a need for an improved NISQ-processor architecture employing individual Rydberg atoms capable of operating with a high number of physical qubits, typically on the scale of 1000 qubits.

According to the invention, this aim is achieved by virtue of conjoint use of a three-dimensional array of optical tweezers loaded by gray molasses (instead of a simple magneto-optical trap) and of a cryogenic environment, typically at 4 K. Use of a cryogenic environment poses considerable technical difficulties, which are surmounted by using a particular opto-mechanical setup. Advantageously, furthermore, agile laser beams, manipulated by optical deflectors, are used for the Raman manipulation, the addressment and the Rydberg excitation of the trapped atoms; specifically, this technique proves to be particularly easily scalable to arrays of large dimensions.

One subject of the invention is therefore a quantum-computing device comprising:
an atom-trapping unit comprising a first laser source suitable for generating a trapping optical beam, a spatial light modulator configured to modulate said trapping optical beam, a first aspherical lens configured to focus the trapping optical beam modulated by the spatial light modulator and a second aspherical lens placed facing the first aspherical lens along a given optical axis, said lens being suitable for collimating the trapping optical beam focused by the first aspherical lens, the spatial light modulator being configured so as to interact with the first aspherical lens to generate a three-dimensional array of optical tweezers in a space between the first and second aspherical lenses, each of the optical tweezers being capable of trapping at most one atom;
an atom source, configured to generate a beam of atoms that is directed toward the space containing the three-dimensional array of optical tweezers;
a magneto-optical system for cooling the atoms of the beam, configured to generate, in the space containing the three-dimensional array of optical tweezers, a cloud of atoms capable of being trapped by said optical tweezers; and
a system for applying quantum logic gates to atoms trapped in the optical tweezers of the three-dimensional array of optical tweezers; and
an ultra-high-vacuum chamber containing at least the first and the second aspherical lenses, as well as the space between the two said lenses; and
a cryostat for establishing a cryogenic temperature in the ultra-high-vacuum chamber;
   characterized in that:
the magneto-optical system for cooling the atoms of the beam is of the gray-molasses type; and in that
said atom-trapping unit comprises two lens-holding barrels placed facing, each barrel holding one of said aspherical lenses with a clearance in a plane perpendicular to a longitudinal axis of the barrel, coinciding with an optical axis of the lens, said clearance being sufficient to compensate for a differential in thermal contraction between the barrel and the lens during a passage from an ambient temperature to said cryogenic temperature.

According to particular embodiments of such a device:

Each of the lens-holding barrels may have, at one end, a stop and may contain a spring suitable for exerting, on the aspherical lens, a force oriented along said longitudinal axis, pressing the lens against the stop.

Each of the aspherical lenses may have, on its faces, a conductive coating that is transparent at the wavelength of said trapping beam, said coating having a thickness smaller than 100 nanometers.

The device may also comprise a camera that interacts with the second aspherical lens to acquire an image of atoms trapped by the optical tweezers of the three-dimensional array.

The device may further comprise an assembling unit configured to create and move a movable optical tweezer in one of the planes of said three-dimensional array of optical tweezers.

More particularly, the assembling unit may comprise:
a second laser source configured to generate an assembling optical beam;
a first deformable lens, having a variable focal length, configured to focus the assembling optical beam so as to form an optical tweezer the position of which may be varied axially so as to select a plane of said three-dimensional array of optical tweezers, and
two acousto-optical deflectors configured to move said movable optical tweezer in the selected optical-tweezer plane along two directions perpendicular to the axis of the assembling optical beam.

The device may further comprise, inside the ultra-high-vacuum chamber:
a set of electrodes configured to generate an electrostatic field the strength and direction of which may be adjusted in the space containing the three-dimensional array of optical tweezers; and
a set of coils configured to generate a magnetostatic field the strength and direction of which may be adjusted in the space containing the three-dimensional array of optical tweezers.

More particularly, said sets of electrodes and coils may be arranged between the space containing the three-dimensional array of optical tweezers and a cold plane of the cryostat and provide an entryway to said space for at least one laser beam, the device also comprising a steering mirror, also located inside the ultra-high-vacuum chamber, for directing said laser beam through said entryway.

The system for applying quantum logic gates may comprise at least:
a. a third laser source configured to generate an addressing optical beam, suitable for applying light to move atoms trapped in the three-dimensional array of optical tweezers,
b. a second deformable lens, having a variable focal length, configured to focus said addressing optical beam in said three-dimensional array of optical tweezers, and
c. two acousto-optical deflectors that are configured to spatially control the direction of propagation of the addressing optical beam, and that interact with said second deformable lens to focus said addressing beam on one optical tweezer of said array.

The magneto-optical cooling system may comprise a fourth laser source configured to generate an optical laser cooling beam and a steering mirror, located inside the ultra-high-vacuum chamber, for directing said optical cooling beam in a direction of propagation opposite to that of the beam of atoms.

Said three-dimensional array of optical tweezers preferably comprises at least 5 planes of at least 16×16 optical tweezers.

Said cryostat may be, in particular, a 4 K cryostat.

Said atom source may be, in particular, a source of rubidium atoms.

Another subject of the invention is the use of such a device to carry out quantum computations on a set of at least 500 and preferably at least 1000 qubits of the Rydberg-atom type.

Below, by “cryogenic temperature”, what is meant is a temperature lower than 150 K, and preferably lower than or equal to 4 K, and by “ultra-high-vacuum”, what is meant is a vacuum characterized by a residual pressure lower than 10⁻¹² mbar and preferably no higher than 10⁻¹⁴ mbar.

The appended drawings illustrate the invention:

FIG. 1 illustrates the principle of the rearrangement of a three-dimensional array of optical tweezers loaded by gray molasses;

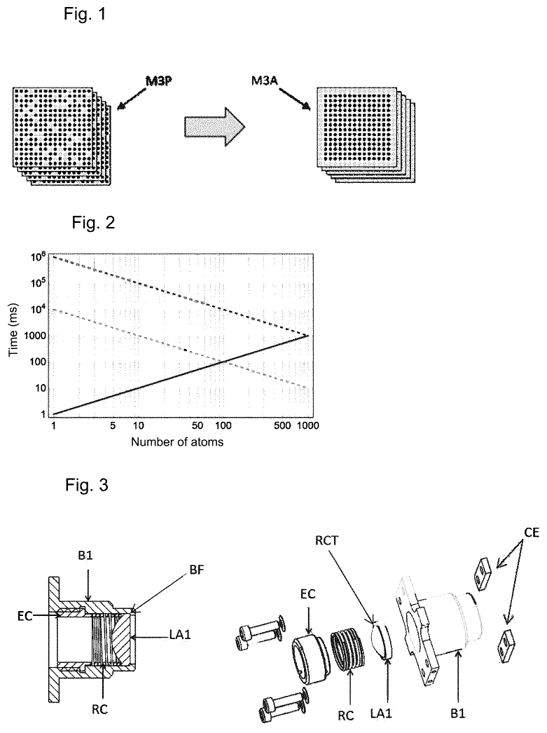

FIG. 2 illustrates the advantage of using a cryogenic environment;

FIG. 3 is a cross-sectional view (left-hand portion) and an exploded view (right-hand portion) of a lens-holding barrel according to one embodiment of the invention;

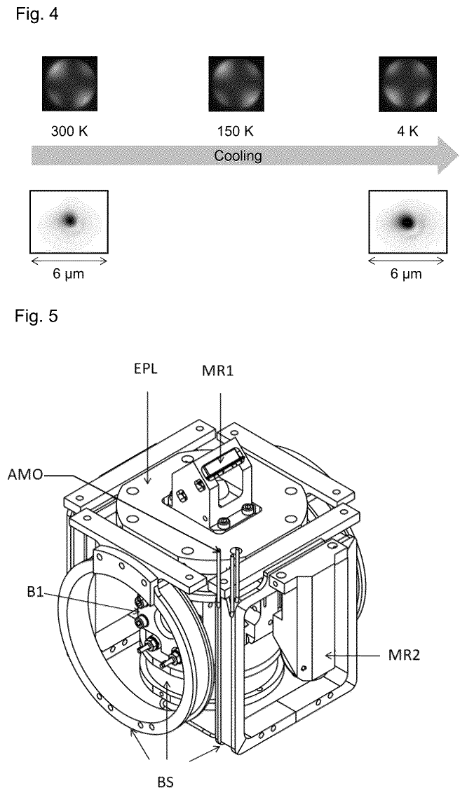

FIG. 4 illustrates the compatibility of the barrel of FIG. 3 with cooling to 4 K;

FIG. 5 is a perspective view of a lens-holding assembly according to one embodiment of the invention;

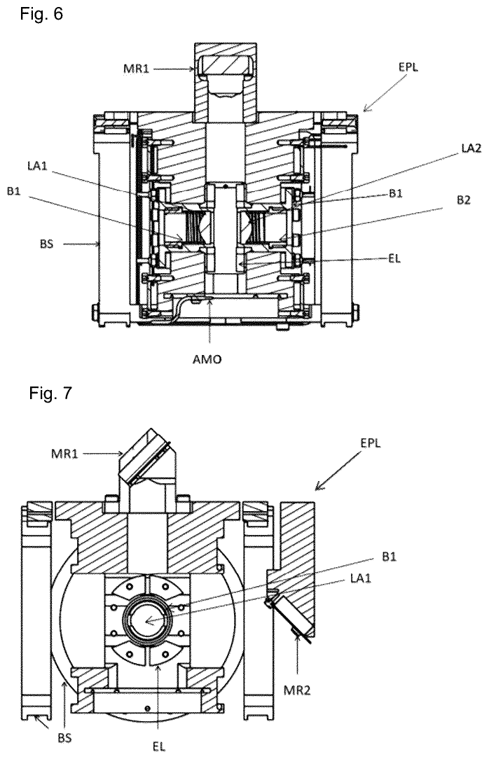

FIG. 6 is a first cross-sectional view of this lens-holding assembly;

FIG. 7 is a second cross-sectional view of this lens-holding assembly;

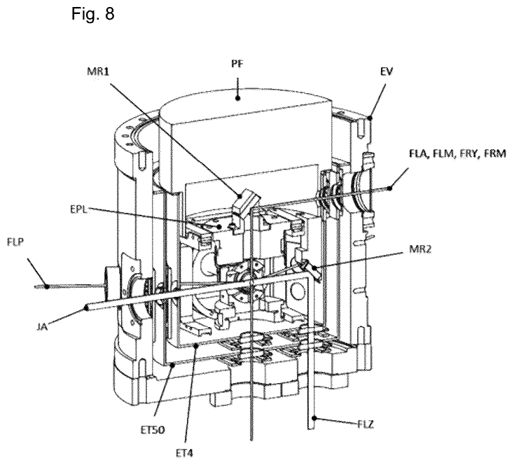

FIG. 8 is a cross-sectional view of a lens-holding assembly inserted in a cryogenic chamber according to one embodiment of the invention;

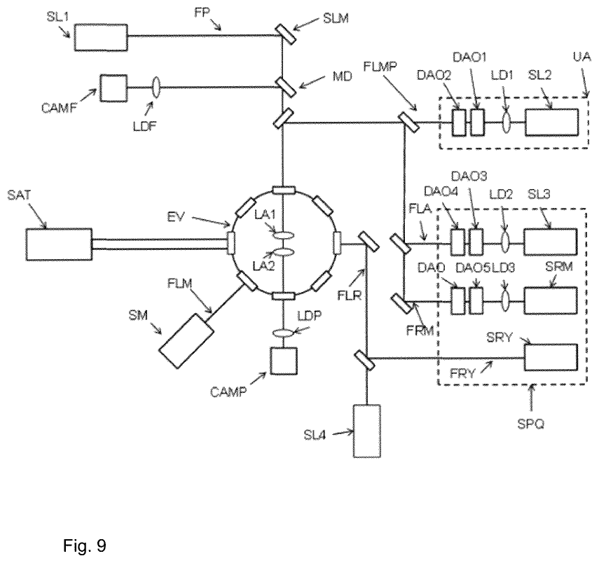

FIG. 9 is a schematic representation of a device according to one embodiment of the invention;

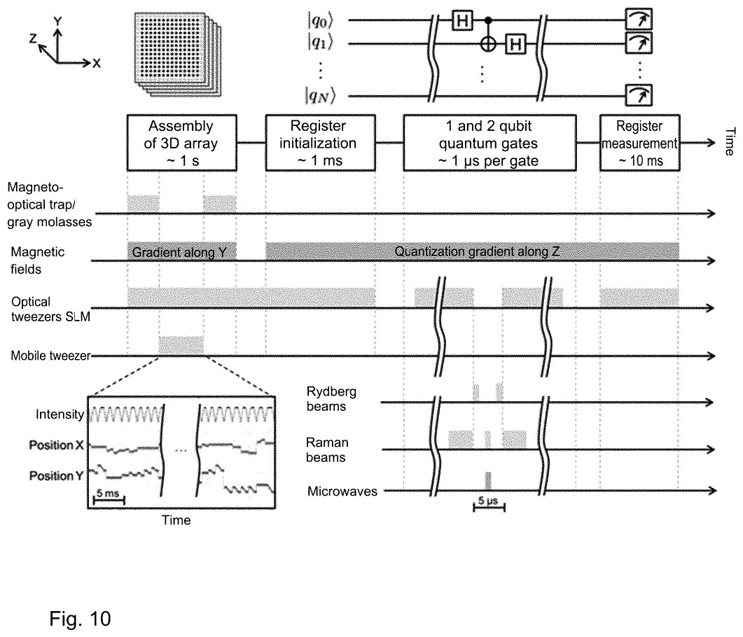

FIG. 10 illustrates the use of a device according to one embodiment of the invention to perform operations on qubits.

The following is the first obstacle to production of an array comprising a number of individual atoms of the order of 1000.

The traditional approach consists in using two-dimensional (2D) arrays of optical tweezers loaded via a simple magneto-optical trap. In such a configuration, the average fill ratio of the optical tweezers cannot exceed 50% for physical reasons. Thus, to trap N atoms it is necessary to have an array of 2N optical tweezers, which will be filled randomly. A rearrangement of the atoms then allows an ordered array to be obtained.

Concretely, to trap N=1000 atoms, a square array of at least 2000 tweezers, 45×45 traps for example, would therefore be required. However, as two adjacent traps must be separated by about five microns, the linear dimension of the array exceeds 200 μm, i.e. is much larger than the field of an aspherical lens of the type commonly used to produce matrices of optical tweezers. Specifically, geometric aberrations, and above all coma, prevent diffraction-limited optical tweezers from being produced at such large distances from the optical axis. Furthermore, as about 5 mW of laser power at 850 nm is required per optical tweezer, a total of |10 W of power must be shone on the atoms: this leads to thermal problems, in particular (but not only) in the spatial light modulator (SLM) used, in combination with an aspherical lens, to holographically generate the arrays of optical tweezers.

This double problem is solved, according to the invention, via the combined use of three-dimensional arrays of optical tweezers ([Leseleuc de Kerouara 2018] and [Barredo 2018]) and of a technique for loading individual atoms into the optical tweezers, called gray-molasses loading—this technique is described (in the case of 2D matrices) in [Brown 2019].

It is demonstrated in [Brown 2019] that, by loading the optical tweezers not solely via a conventional magneto-optical trap, but by gray molasses, it is possible to obtain load ratios exceeding 80%, with a laser power of only 3 mW per optical tweezer. To obtain 1000 atoms, only about 1250 traps are thus required, this therefore requiring 3.8 W of laser power instead of 10 W. The thermal problems mentioned above are thus very considerably reduced.

However, an array of 1250 two-dimensional traps still represents a grid of 35×35 traps, too large for the field of an aspherical lens. It is for this reason that a three-dimensional array, such as the three-dimensional arrays demonstrated in [Leseleuc de Kerouara 2018] and [Barredo 2018], which are perfectly compatible with the use of gray molasses, is used.

The left-hand portion of FIG. 1 shows a 3D array M3P of optical tweezers formed of 5 planes of 16×16 optical tweezers, loaded to about 80% with atoms (white circles: empty optical tweezers; black circles: loaded optical tweezers). The array therefore contains about 1024 atoms and 256 randomly arranged empty optical tweezers. A rearrangement (right-hand portion of the figure) allows an ordered and compact 3D array M3A of atoms to be obtained.

All of the traps remain at a distance smaller than 40 μm from the focal point of the lens, a value for which the optical quality of the tweezers remains very close to the diffraction limit.

There remains, however, a major problem to be solved. Specifically, the time required to rearrange the atoms in the disordered array M3P is proportional to the number of atoms, and is equal to about 1 ms/atom (solid line in FIG. 2). The ordered array M3A therefore requires about 1 s to form.

However, in prior-art systems, operating in ultra-high vacuum with a residual pressure of the order of 10⁻¹² mbar, the lifetime of an atom in a trap—which lifetime is limited by collisions with residual gas molecules—is about 10 s. This means that the probability that an array of N atoms is not affected by a collision decreases exponentially over time, with a time constant of 10/N seconds (gray dashed line in FIG. 2). Thus, once N exceeds about one hundred, the assembly time exceeds the lifetime of the configuration, and the assembling operation becomes completely ineffective. To get from 100 to 1000 atoms, as the assembly time increases by a factor of ten, and as the lifetime of the array would decrease by a factor of ten if the ultra-high vacuum quality were kept constant, it is necessary to improve the vacuum quality by a factor of one hundred, and therefore descend to a residual pressure of the order of 10⁻¹⁴ mbar (black dashed line).

To reach such ultra-high vacuum levels, better than 10⁻¹⁴ mbar or less, it is necessary to work in a cryogenic environment, typically at 4 K, to ensure that all the constituent species of the residual gas (in particular dihydrogen, which is always present in ultra-high-vacuum systems) are effectively cryo-pumped by the cold walls. The use of a cryogenic environment is thus another aspect of the invention.

Working in an ultra-high-vacuum chamber EV in a cryogenic environment places constraints on the choice of materials and on the overall design of the device.

As regards the choice of materials, compatibility with ultra-high vacuum requires very low degassing rates and the materials to be able to be baked at 200° C., this excluding polymers, adhesives, etc. that are usually widely used in cryogenics. Furthermore, the use of a 4 K cryogenic environment requires the components to have a good thermal conductivity (in order to ensure their thermalization) and mechanical properties that remain satisfactory at 4 K.

Regarding the overall design of the device, the main challenge consists in providing for the fact that the system must pass from a temperature of 500 K (during baking) to 4 K (in cryogenic operation), and therefore undergo considerable thermal expansions and contractions, while meeting very strict tolerances.

The “core” of a Rydberg-atom quantum processor consists of two aspherical converging lenses LA1, LA2 facing each other in 2f configuration (see FIG. 6). One lens (LA1, for example) focuses a laser beam previously modulated by an optical phase modulator SLM located outside the cryostat, to form the array M3P of optical tweezers, the other lens (LA2) allows this optical beam to be collimated, so as to ensure the light exits from the cryostat in a controlled manner, but above all so as to image, on an auxiliary camera placed behind the device, the array of traps, this being crucial to calibration of the assembling device. Despite the aforementioned thermal contractions, the alignment of the optical axes of the two lenses must be achieved to within a tolerance of typically less than ten microns.

According to one embodiment of the invention, the aspherical lenses LA1, LA2 are mounted in a lens-holding barrel B1, for example one made of a copper-beryllium alloy (CuBe) in order to ensure both good mechanical properties and good properties in respect of thermal conduction. On cooling to temperature, the metal barrel contracts by about 0.3%, while the contraction of the glass of the lens is typically 10 times less. If the lenses were mounted fast at room temperature, the differential thermal contraction would lead, on cooling to temperature, to a radial compression of the lens, inducing stresses and therefore a deformation of the lens that would give rise to unacceptable geometric aberrations. For this reason, the inside diameter of the barrel is, at room temperature, slightly larger than the inside diameter of the lens, the clearance (about 0.05 mm) being calculated so that, after thermal contraction from 300K to 4K, the lens fits perfectly in the barrel. A compression spring RC, also made of CuBe, and kept compressed by a CuBe nut EC screwed into an internal thread of the barrel, presses on the lens to press it against a stop BF at the bottom of the barrel. The bores intended to receive the barrels are preferably formed in a single operation of drilling of the barrel-holding block, thus ensuring coaxiality.

The inter-lens spacing is, by construction, larger than 2f at room temperature, by an amount calculated so that the thermal contraction during cooling to 4 K perfectly compensates for it; adjustment is ensured by the presence of shims (CE) made in OFHC copper between the barrel and the lens holder, the thickness of which may be refined by polishing if necessary.

This setup is illustrated in FIG. 3. An identical setup, using a barrel B2, is used for the aspherical lens LA2.

Rydberg states are extremely sensitive to stray electrostatic fields; to avoid them it is important to be able to make the surface of the lenses directly facing the atoms conductive, and therefore equipotential. To do this, a coating RCT made of a material that is conductive but transparent at the (typically visible or near-infrared) wavelength of the trapping beam is applied to the lenses. This coating is for example made of indium-tin oxide (ITO). However, the ITO layer has a residual optical absorption that may be as much as a few percent. For trap laser powers of around 4 W, this would lead to several tens of mW of thermal load being applied to the cryostat, which would lead to non-negligible heating of the lenses. The lenses will therefore be treated with a thickness of ITO of only 50 nm, which is feasible and sufficient to ensure a good static conductivity.

FIG. 4 illustrates the result of a cooling test carried out on aspherical lenses. The images at the top of the figure were obtained by placing the pair of lenses between a crossed polarizer and analyzer: in the absence of stresses, a black cross should be observed, and in particular the center of the field should be black. This is the case at 300 K (left), at 150 K (center) and at 4 K (right). A quantitative analysis of the images showed that, at 4 K, the contrast was as high as at 300 K. During cooling, a very slight transient drop in contrast was observed. This drop is due to the fact that the lens, the thermal conductivity of which is low, cools less quickly than the CuBe barrel (good conductor of heat), which therefore temporarily exerts (reversible) mechanical stresses on the lens. The bottom images show the beam in the trapping plane imaged on a CCD camera, in both cases the spot has a 1/e² radius smaller than 1.1 μm and low aberrations, i.e. is good enough to trap individual atoms.

Manipulation of atoms requires the ability to apply, during an experimental sequence, pulses of various electromagnetic fields: electrostatic fields, static magnetic fields, microwave fields. The presence of the walls of the vacuum chamber and of two heat shields at 50 K and at 4 K (references ET50 and ET4 in FIG. 8) necessary for the cryostat to operate excludes applying them from outside the chamber, because any applied microwave fields would be screened.

Thus, according to one embodiment of the invention, the two barrels B1 and B2 are integrated into a lens-holding assembly EPL that is also equipped with at least eight electrodes EL allowing a uniform electric field of arbitrary direction to be generated (in order to be able to compensate for any stray electric fields that would otherwise disturb the Rydberg states); at least three pairs of coils BS allowing static magnetic fields of several tens of Gauss that may be uniform or have a gradient and that are of arbitrary direction to be created (in order to avoid applying an excessive thermal load, due to Joule heating, to the cryostat, the coils are preferably made of NbTi superconducting wire in a copper matrix); and at least three microwave antennas AMO that are pairwise orthogonal, allowing fields that oscillate at about ten GHz and the polarization of which at the atoms is controllable via adjustment of the relative phases of the three components to be applied. In one simplified embodiment of the invention, the microwave antennas may not be present; however, this limits the choice of the quantum-computing protocols that may be implemented.

The lens-holding assembly must also guarantee optical access is possible in several directions, in order to allow the atoms to be cooled, trapped, addressed, excited and observed (see FIG. 8 and FIG. 9). FIG. 5, FIG. 6 and FIG. 7 show in detail a lens-holding assembly according to one embodiment of the invention.

In the embodiment of FIGS. 5 to 9, the lens-holding assembly includes two steering mirrors MR1, MR2.

The mirror MR1 allows the assembling laser beam FLA, the cooling laser beam FLM (which forms both a magneto-optical trap and a gray molasses), the Raman excitation beam FRA and the Rydberg excitation beam FRY, which are all delivered to the cryogenic chamber in a horizontal direction, to be directed vertically downward. These beams cannot enter into the ultra-high-vacuum chamber EV from above because of the presence of the cold plane PF of the cryostat (see FIG. 8). Also, the mirror MR1 solves a problem with bulk related to the use of a cryogenic environment.

The mirror MR2 allows a Zeeman cooling laser beam FLR that propagates in a direction opposite to that of an atomic jet JA generated by an atom source (typically a source of Rubidium atoms) that feeds the array of optical tweezers to be deviated by 90°. The Zeeman cooling laser beam generally passes through a porthole located facing the atom beam. In a device operating at room temperature, the atoms of the jet settle only temporarily on the porthole, and hence it does not get opaque. At 4 K, the rubidium jet would quickly make the window completely opaque. This problem is solved by using the steering mirror MR2, which gets covered with rubidium over time but remains reflective to the cooling laser beam.

FIG. 9 is a schematic representation of a device according to one embodiment of the invention, seen from above. The ultra-high-vacuum chamber EV is connected to an atom source SAT that generates the aforementioned atom jet JA. A laser source SL4 generates the aforementioned Zeeman cooling beam FLR, which cools the atoms of the jet JA before they reach the trapping region.

Laser sources SM generate laser beams that propagate toward then away from one another in three different directions (a single source and a single beam have been shown) to generate both a magneto-optical trap (the trapping magnetic field, which has a gradient, is generated by the coils BS, which are in an anti-Helmholtz configuration) and gray optical molasses. A first laser source SL1 generates a trapping beam FP that, after having been modulated by the spatial light modulator SLM and focused by the aspherical lens LA1, generates the three-dimensional array of optical tweezers. This beam, collimated by the lens LA2, leaves the chamber and reaches a camera CAMP that, using the LDP lens, allows an image of the trapped atoms to be obtained.

The assembling unit UA comprises a laser source SL2 for generating a laser beam FLPM forming a movable optical tweezer allowing the atoms trapped in the array M3P to be moved in order to form the compact and regular array M3A of atoms. The movable optical tweezer must be able to move in three dimensions: the axial movement is ensured via an electronically controlled deformable lens LD1 of variable focal length, the movements in a plane perpendicular to the optical axis is ensured via two acousto-optical deflectors DAO1, DAO2.

A system SPQ for applying quantum logic gates comprises at least one laser source SRM for generating a pair of co-propagating Raman beams FRM and at least one laser source SRY for generating a Rydberg excitation beam FRY. The one or more Rydberg beams FRY illuminate the entire three-dimensional array of atoms, in a blanket manner. Atom-by-atom addressment is obtained by selectively focusing, on an atom, two addressing beams FLA, which apply light to generate a movement. Each beam FLA is generated by a laser source SL3, focused both by the aspherical lens LA1 and by an electronically controlled deformable lens LD2 (the latter, of variable focal length, allows a plane of the array of trapped atoms to be selected) and moved in a plane perpendicular to the optical axis by two acousto-optical deflectors DAO3, DAO4; for the sake of simplicity, a single addressing beam and its generating system have been shown. Likewise, the Raman beams FRM are applied selectively to one atom by virtue of a deformable lens LD3 and two acousto-optical deflectors DAO5, DAO6.

FIG. 10 illustrates the use of the device of FIG. 8 and FIG. 9 to perform quantum computations.

As mentioned above, the qubits are encoded on two Zeeman sub-levels of the hyperfine structure of the ground state of the atoms; the qubit register is initialized by blanket optical pumping with a beam FRM that covers the entire array. Coherence times may be as long as one second if the Zeeman sub-levels on which the qubit is encoded are suitably chosen (so-called clock transition).

The state of the qubits is read via selective fluorescence imaging, for example using the technique described in [Fuhrmanek 2011], but extended to a three-dimensional array.

Regarding application of gates to a qubit, this is done using a pair of co-propagating Raman beams FRM that are focused on the desired qubit using acousto-optical deflectors DAO5, DAO6 and an electronically controlled deformable lens LD3, as explained with reference to FIG. 9. Because they are highly focused, the Raman beams, which are of similar size to the optical tweezers, diverge strongly with distance from the plane in which they are focused, this meaning that crosstalk between facing atoms located in successive planes is low.

To apply two-qubit gates (which requires first the control atom then the target atom to be selectively excited to a Rydberg state within the array), the adopted solution consists in employing blanket Rydberg excitation beams FRY (which cover the entire array; to do this, the excitation scheme referred to as the inverted two-photon scheme is used because the available laser powers allow, with beams of the order of about one-hundred μm in diameter, Rabi frequencies of several MHz to be reached) and in selecting the atoms in question by applying light to move them using two independent detuned addressing beams FLA that also pass, as was explained above, through a combination of a deformable lens (selection of the atom plane) and of a 2D acousto-optical deflector (selection of the atom in its plane). This allows the Rydberg excitation pulses to be applied to the two atoms at intervals of a few hundred ns, in order to maximize the fidelities of the gates. As a variant, it would be possible to use a highly focused Rydberg excitation beam directed onto the atoms to be excited by acousto-optical deflectors, but this is made complex by the high intensities involved.

As regards both the Raman beams and the addressing beams allowing Rydberg excitation, the provision of independent acousto-optical deflectors allows optionally successive pulses to be applied to separate atoms at rates of the order of one MHz with a high level of agility.

The residual crosstalk of the one-qubit gates, which is due to the fact that the Raman beams also illuminate (although weakly because of their divergence) atoms in the planes adjacent to the plane of interest, is not necessarily a handicap in a high number of interesting applications of NISQ processors, such as variational quantum simulation (VQS). In contrast, in “conventional” quantum-computing applications (circuit model). crosstalk should be minimized. To do this, in one variant of the invention, it is possible to envision, with the same techniques, using two pairs of aspherical lenses, allowing the Raman beams to be focused along two orthogonal axes, so as to ensure coupling between the two states of the qubit occurs only for the addressed atom, since it alone is covered by the two Raman beams.

FIG. 10 shows that:

The array is loaded by activating the trapping beam to form the three-dimensional array of optical tweezers and the magneto-optical trap and gray molasses, and applying a magnetic field having a gradient along the Y-axis using superconducting coils in an anti-Helmholtz configuration. More precisely, the magneto-optical trap is activated first to form a cloud of cold atoms, then it is deactivated and the gray molasses is activated to achieve further cooling. Next, the assembling operation is carried out by means of the movable optical tweezer (beam FLA), the gray molasses being turned off, then turned on again once the assembling operation has ended.

Initialization of the register requires a quantization magnetic field to be applied along the Z-axis, which field is maintained throughout the duration of a quantum computation. The application of 1 and 2 qubit quantum gates is achieved using Rydberg, Raman and microwave beams. When atoms are raised to Rydberg states, it is necessary to temporarily disable the trapping beam. In certain quantum-computing protocols, it may be useful to apply a microwave field to induce transitions between two separate Rydberg states.

The qubit register is read using the camera CAMF, which detects the fluorescence of the trapped atoms. A lens LDF forms an image of the array of atoms on the camera CAMF and a dichroic mirror MD selects the wavelength of the fluorescent emission.

The invention has been described with reference to one particular embodiment, but many variants are possible. For example, the geometry of the lens-holding assembly may be different from that of FIGS. 5 to 7. Likewise, the materials used are given merely by way of example. Other schemes of excitation of the atoms and of application of quantum gates may be used, leading to a different system architecture. The only elements essential to the invention are the use of a three-dimensional array of optical tweezers, loading thereof by gray molasses, the cryogenic environment and the opto-mechanical setup compatible with such an environment.

### BIBLIOGRAPHY

[Preskill 2018]: John Preskill “Quantum Computing in the NISQ era and beyond” arXiv:1801.00862v3, 31 Jul. 2018.
[Saffman 2010]: M. Saffman et al. “Quantum information with Rydberg atoms” arXiv:0909.4777v3, 12 May 2010.
[Leseleuc de Kerouara 2018]: Sylvain de Leseleuc de Kerouara “Quantum simulation of spin models with assembled arrays of Rydberg atoms”, thesis defended on Dec. 10, 2018.
[Barredo 2018]: D. Barredo et al., “Synthetic three-dimensional atomic structures assembled atom by atom”, Nature 561, 79 (2018).
[Brown 2019]: M. O. Brown et al., “Gray-Molasses Optical-Tweezer Loading: Controlling Collisions for Scaling Atom-Array Assembly”, Phys. Rev. X 9, 011057 (2019).
[Fuhrman 2011]: Fuhrmanek et al., “Free-space lossless state-detection of a single trapped atom”, Phys. Rev. Lett. 106, 133003 (2011).

1.-14. (canceled)

15. A quantum-computing device comprising:
an atom-trapping unit comprising a first laser source (SL1) suitable for generating a trapping optical beam (FP), a spatial light modulator (SLM) configured to modulate said trapping optical beam, a first aspherical lens (LA1) configured to focus the trapping optical beam modulated by the spatial light modulator and a second aspherical lens (LA2) placed facing the first aspherical lens along a given optical axis, said lens being suitable for collimating the trapping optical beam focused by the first aspherical lens, the spatial light modulator being configured so as to interact with the first aspherical lens to generate a three-dimensional array of optical tweezers (M3P) in a space between the first and second aspherical lenses, each of the optical tweezers being capable of trapping at most one atom;
an atom source (SAT), configured to generate a beam of atoms (JA) that is directed toward the space containing the three-dimensional array of optical tweezers;
a magneto-optical system (SM) for cooling the atoms of the beam, configured to generate, in the space containing the three-dimensional array of optical tweezers, a cloud of atoms capable of being trapped by said optical tweezers;
a system (SPQ) for applying quantum logic gates to atoms trapped in the optical tweezers of the three-dimensional array of optical tweezers;
an ultra-high-vacuum chamber (EV) containing at least the first and the second aspherical lenses, as well as the space between the two said lenses;
a cryostat for establishing a cryogenic temperature in the ultra-high-vacuum chamber;
wherein
the magneto-optical system for cooling the atoms of the beam is of the gray-molasses type; and in that
said atom-trapping unit comprises two lens-holding barrels (B1, B2) placed facing, each barrel holding one of said aspherical lenses with a clearance in a plane perpendicular to a longitudinal axis of the barrel, coinciding with an optical axis of the lens, said clearance being sufficient to compensate for a differential in thermal contraction between the barrel and the lens during a passage from an ambient temperature to said cryogenic temperature, each of the lens-holding barrels having, at one end, a stop (BF) and containing a spring (RC) suitable for exerting, on the aspherical lens, a force oriented along said longitudinal axis, pressing the lens against the stop.

16. The device as claimed in claim 15, wherein each of the aspherical lenses has, on its faces, a conductive coating (RCT) that is transparent at the wavelength of said trapping beam, said coating having a thickness smaller than 100 nanometers.

17. The device as claimed in claim 15, also comprising a camera (CAMP) that interacts with the second aspherical lens to acquire an image of atoms trapped by the optical tweezers of the three-dimensional array.

18. The device as claimed in claim 15, further comprising an assembling unit (UA) configured to create and move a movable optical tweezer in one of the planes of said three-dimensional array of optical tweezers.

19. The device as claimed in claim 18, wherein the assembling unit comprises:
a second laser source (SL2) configured to generate an assembling optical beam;
a first deformable lens (LD1), having a variable focal length, configured to focus the assembling optical beam so as to form an optical tweezer the position of which may be varied axially so as to select a plane of said three-dimensional array of optical tweezers, and
two acousto-optical deflectors (DAO1, DAO2) configured to move said movable optical tweezer in the selected optical-tweezer plane along two directions perpendicular to the axis of the assembling optical beam.

20. The device as claimed in claim 15, further comprising, inside the ultra-high-vacuum chamber:
a set of electrodes (EL) configured to generate an electrostatic field the strength and direction of which may be adjusted in the space containing the three-dimensional array of optical tweezers; and
a set of coils (BS) configured to generate a magnetostatic field the strength and direction of which may be adjusted in the space containing the three-dimensional array of optical tweezers.

21. The device as claimed in claim 20, wherein said sets of electrodes and coils are arranged between the space containing the three-dimensional array of optical tweezers and a cold plane (PF) of the cryostat and provide an entryway to said space for at least one laser beam, the device also comprising a steering mirror (MR1), also located inside the ultra-high-vacuum chamber, for directing said laser beam through said entryway.

22. The device as claimed in claim 15, wherein the system for applying quantum logic gates comprises at least:
a. at least a third laser source (SL3) configured to generate an addressing optical beam (FLA), suitable for applying light to move atoms trapped in the three-dimensional array of optical tweezers,
b. a second deformable lens (LD2), having a variable focal length, configured to focus said addressing optical beam in said three-dimensional array of optical tweezers, and
c. two acousto-optical deflectors (DOA3, DOA4) that are configured to spatially control the direction of propagation of the addressing optical beam, and that interact with said second deformable lens to focus said addressing beam on one optical tweezer of said array.

23. The device as claimed in claim 15, wherein the magneto-optical cooling system comprises a fourth laser source (SL4) configured to generate an optical laser cooling beam and a steering mirror (MR2), located inside the ultra-high-vacuum chamber, for directing said optical cooling beam in a direction of propagation opposite to that of the beam of atoms.

24. The device as claimed in claim 15, wherein said three-dimensional array of optical tweezers comprises at least 5 planes of at least 16×16 optical tweezers.

25. The device as claimed in claim 15, wherein said cryostat is a 4 K cryostat.

26. The device as claimed in claim 15, wherein said atom source is a source of rubidium atoms.

27. The use of a device as claimed in claim 15 to carry out quantum computations on a set of at least 500 and preferably at least 1000 qubits of the Rydberg-atom type.
